(19) United States
(12) Patent Application Publication
(10) Pub. No.: US 2003/0179373 A1
(43) Pub. Date: Sep. 25, 2003

(54) Method for position and/or angle measurement by means of gratings

(76) Inventors: Anders Magnusson, Goteborg (SE); Sverker Hard, Goteborg (SE)

Correspondence Address: BIRCH STEWART KOLASCH & BIRCH, PO BOX 747, FALLS CHURCH, VA, 22040-0747, US

(21) Appl. No.: 10/296,963

(22) PCT Filed: May 29, 2001
(86) PCT No.: PCT/SE01/01209

(30) Foreign Application Priority Data
May 29, 2000 (SE) 0001992.7

(51) Int. Cl. G01J 3/28

(52) U.S. Cl. 356/328

(57) ABSTRACT

The present invention relates to an optical measurement device, comprising first phase grating and second phase grating, a light source, and at least two optical detectors, said first and second gratings being stationary binary gratings on transparent carrier. The first phase grating is arranged to be reproduced on said second phase grating upon illumination with the light source, which reproduction is coherently achieved, so that periods of the image of the first phase grating and the second phase grating are in an integral relationship with respect to one another, and so that the grating lines of the image of one grating and the other grating are parallel. A relative positional displacement between the image of one phase grating on the other phase grating is registered by said at least two optical detectors.

With the intention to guide as much as possible of the light power to the diffraction order ±1, and to suppress the power in the order ±1, an actual four level grating is achieved by coherently reproducing a 180° binary phase grating upon a 90° binary phase grating with the respective periods well matched. The measured total power fractions in the orders +1 and −1 were 54% and 2%, respectively.

### BACKGROUND OF THE INVENTION

Recently, spatial light modulators (SLM), based on ferroelectric liquid crystals (FLC), have become commercially available at reasonable cost. During operation in phase mode, such SLM:s may be utilized to guide laser light through controlled diffraction, see, for instance, (D1) S. E. Broomfield, M. A. A. Neil, E. G. S. Paige, and G. G. Yang, “Programmable binary phase-only optical device based on ferroelectric liquid crystal SLM,” Electr. Lett. 28, pp. 26-28 (1992). An attractive feature of FLC SLM:s is their relatively high switching speed, which is in the microsecond range; this is described in N. A. Clark and S. T. Lagerwall, “Submicrosecond bistable electro-optic switching in liquid crystals”, Appl. Phys. Lett. 36, pp. 899-901 (1980). However, they are of a binary nature, which limits the diffractory efficiency to 40,5% in applications for guidance of laser beams, which is the application. One way of increasing the overall efficiency of a beam guide is to cascade two or more FLC SLM:s, so that more phase levels than two are obtained, see, for instance, M. O. Freeman, T. A. Brown, and D. M. Walba, “Quantized complex ferroelectric liquid crystal spatial light modulators,” Appl. Opt. 31, pp. 3917-3929 (1992), and S. E. Broomfield, M. A. A. Neil, and E. G. S. Paige, “Programmable multiple-level phase modulation that uses ferroelectric liquid-crystal spatial light modulators,” Appl. Opt. 34, pp. 6652-6665 (1995). Here, the feasibility of this approach is investigated by reproducing a stationary binary phase grating on another grating, where the gratings are prepared in photo resist on the same substrate by direct writing electron beam lithography.

Reference D1 refers to spatial light modulators (SLM:s) of the liquid crystal type. By reproducing one SLM upon another SLM, it becomes possible to form phase grating-structures with four levels in the image plane, partly corresponding to the invention. However, according to the invention, simple cheap stationary binary gratings on glass slides (transparent carriers) are used instead of expensive SLM:s (the SLM:s may cost SEK 100,000 apiece). The idea of the SLM:s is that the geometry should be fixed. Instead guiding of the light power to different diffraction devices is effected by readjusting the SLM:s through a computer.

The present invention is based on the grating structures themselves being fixed, but they “ride” upon a mechanical arrangement, the geometry of which changes, and where the gratings themselves assist in the measurement of said geometry change. The advantage of the present invention is that the registration is carried out in at least TWO detectors, in such a way that their output signals are compared, i.e., in principle a quotient measurement. The relative signal strength of the two detectors gradually changes during gradual change of the geometry. Among other things, this makes the measurement independent of any variations in the light source, which is not the case when amplitude gratings (measurement through moiré techniques) are used instead of phase gratings. In the latter case, a “fence” might be reproduced onto another “fence”, and the transparency of the reproduction could be measured with ONE detector, which is less sensitive, and more uncertain, than the phase grating technique according to the present invention.

### SHORT DESCRIPTION OF THE INVENTION

The object of the present invention is to provide a measuring device, comprising phase gratings, for very accurate measurement. According to the invention, as much as possible of the impinging light power can be guided to the diffraction order +1, while the power in the order ±1 is suppressed, so that an actual four level grating is accomplished.

This object is achieved through an optical measuring device comprising a first phase grating, and a second phase grating, an illumination means, and at least two optical detectors. The first phase grating is arranged to be reproduced on said second phase grating upon illumination with the illumination means, which reproduction is coherently achieved, so that periods of the image of said first and second phase gratings are in an integral relationship with respect to one another, and so that the grating lines in the image of one grating is parallel to the grating lines in the image of the other grating. A relative positional displacement between the image of one phase grating on the other phase grating is registered by said at least two optical detectors.

### SHORT DESCRIPTION OF THE DRAWINGS

In the following, the invention will be described with reference to a number of embodiments, illustrated in the accompanying drawings, wherein;

FIG. 1 shows the imaging geometry in reflection mode,

FIG. 2 shows the geometry for a 4f imaging in transmission mode,

FIG. 3 shows a computer simulated graph of maximum beam selectivity between the diffraction orders +1 and −1, versus scale error during imaging, and

FIG. 4 shows measured maximum beam selectivity as a function of the positioning of a second grating during a transmission experiment.

### DETAILED DESCRIPTION OF PREFERRED EMBODIMENTS

Briefly, according to the invention, a phase grating (G1) is illuminated by a laser beam, so that it is reproduced upon a second phase grating (G2). The reproduction is performed in such a way that the periods of the G1 image and G2 are in an integral relationship with respect to one another, and that the grating lines of the G1 image and G2 are parallel. The phase modulation depth of one grating should be about 180°, and that for the other grating should be about 90°. During a relative displacement between the G1 image and G2 perpendicularly to the grating lines, the power of the different beams (orders) diffracted from G2 is changed. Said relative positional displacement is detected, according to the invention, by at least two optical detectors, illuminated by one beam each, diffracted from G2. By comparing the magnitude of the detector signals, the positional displacement between the G1 image and G2 is sensitively determined. Said positional displacement may arise, for example, through relative displacement between G1, G2, and the imaging optics in a direction perpendicular to the grating lines, or through rotation of a mirror, which may be part of the imaging optics.

In the following, two examples will be given of a measurement method, as well as a description of experimental arrangements of a transmission type, as well as a reflection type. G1 and G2 are both binary, with phase modulation depths of 180 degrees and 90 degrees, respectively. The corresponding grating periods are 24.0 μm and 12.0 μm. During the experiments, the optical power in the positive and negative diffraction orders of the first order was found to vary by a factor upwards of 50 during a relative displacement of 6 μm between the G1 image and G2. A ten percent relative change in the detector signals, which quite realistically should be detected, would correspond to a positional displacement of 0.1 μm, or, with the described reflection arrangement, a mirror rotation of 0.1 arc seconds.

The purpose of the experiment, according to the examples, was to synthesize a phase grating with four levels, and to do this in the most efficient manner. This requires that the phase step between the levels in the manufactured grating is 90°. This may be achieved by choosing a phase shift of 180° for the first binary grating (G1), and 90° for the second phase grating (G2). For the reproduction, since unit amplification may be used, the periods for the two gratings where chosen to be 24.0 μm and 12.0μ, respectively, and a pulse ratio for both gratings of 50%. One reason for the choice of periods is that the smallest pixel size in FLC SLM:s is in the magnitude of 10 μm. By exposing the gratings on the same substrate in one exposure, it is possible to guarantee that the grating lines will be parallel, and the scale errors between the grating periods minimal. The size of each grating is 4 mm by 4 mm, and the distance between the gratings is 6 mm. Different exposure doses are used for the two gratings in order to allow simultaneous development. After exposure of the resist (2 μm thick PMGI, deposited on an amorphous silica substrate), the sample was developed in steps, and the diffraction efficiency was measured between each step, until the desired phase depths were achieved, see, for instance, M. Larsson, M. Ekberg, F. Nikolajeff, and S. H\dot{a}rd, “Successive development optimization of resist kinoforms manufactured with direct-writing, electron-beam lithography”, Appl. Opt. 33, pp. 1176-1179 (1994). Measurement of the diffraction efficiency showed that the intended phase depths were reached to within 10° for G1 and 5° for G2, after the final developing step.

The performance of the synthesized four level-grating, obtained by reproducing G1 onto G2, was studied in the reflection mode, as well as in the transmission mode.

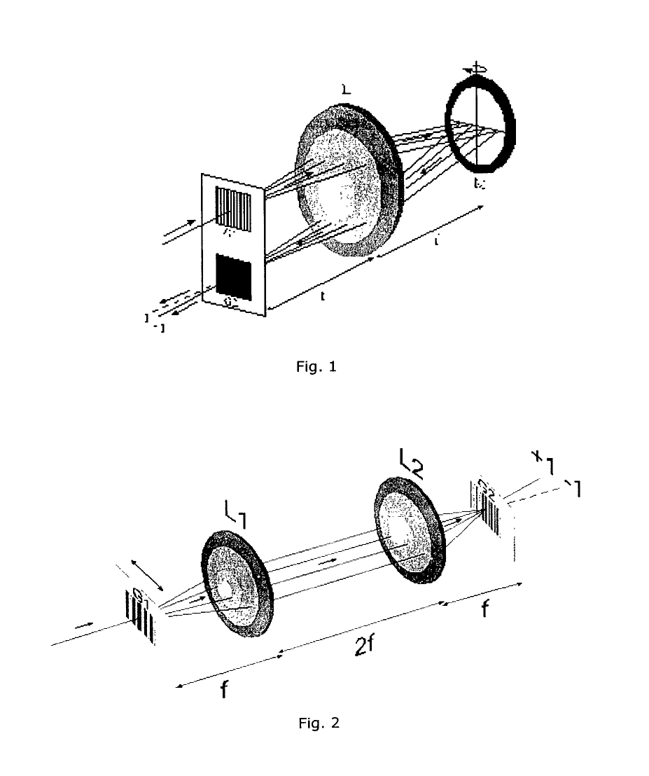

FIG. 1 shows the arrangement for measurement in reflection mode: A collimated Gaussian He—Ne laser beam (wavelength 633 nm, beam diameter 2.0 mm) impinged on G1, the grating lines of which were vertically oriented. Since the gratings were mounted in the rear focal plane of the high quality camera lens objective L (Leitz Leicaflex 11219, Summicron-R 1:2/90 mm, power transmission during single passage at 633 nm: 91%), the beams diffracted from G1 are parallel when leaving the lens L, with the individual rays converging towards the mirror M. The mirror is placed at a right angle to the optical axis of L, and in the front focal plane of L. M is a planar decoupling mirror for a 633 nm He—Ne laser (reflectivity 97,2%), mounted in a laser mirror holder, which is adjustable with a high precision. The mirror diameter is 25 mm, which allows reflection of diffraction orders up to four, the actual f-number of the reproduction being 3.6. Through this arrangement, the low pass-filtered image of G1 impinges on G2, the grating lines of which are vertical too. By rotating M slightly around a vertical axis, the image of G1 may be horizontally displaced. By correct relative adjustment between the G1 image and G2, an actual stair approximation of a right handed saw tooth-grating with four levels can be accomplished. According to the scalar diffraction theory, such a grating would ideally diffract 81.0% of the impinging power in the order +1, with total lack of power in the orders 0 and −1. Qualitatively, this behavior was observed during experiments, and numerical values are given below (Table 1). By rotating M slightly, the image of G1 can be moved 6 μm horizontally, so that the synthesized grating was transformed into a left-handed stair grating with four levels. Thereby, the main part of the diffracted power was transferred to the previous order −1, while the power in the previous order +1 substantially disappeared.

The arrangement in transmission mode for reproduction of G1 onto G2 is shown in FIG. 2. The arrangement consisted of a series of arranged gratings G1 and G2, and the lenses L1 and L2, placed thereinbetween. A laser beam, impinging from the left, is diffracted by G1. The diffracted beams are parallel after the first lens passage. An image of G1 with unit magnification is formed at G2, where an actual phase grating with four levels is formed. Guiding of light power between the orders +1 and −1 demands a relative horizontal and lateral displacement of the gratings. A 4f system was used for the reproduction, which ideally gives unit magnification. With the intention of using lenses resembling each other as much as possible, two achromatic lenses of the same kind (Melles Griot 1:2,8/50 mm) were used, which passed diffraction orders lower than 6 from G1. The measured power transmission of the lenses was 98.0% and 96.6%. During mounting, it was ascertained that the optical axes of L1 and L2 coincided in order to make the laser beam travel along the symmetry axis, to exactly position G1 and G2 in the focal plane of the lenses, and to secure that the grating lines of G1 and G2 were parallel and vertically oriented. The mounting of G1 allows a small horizontal displacement of this grating, perpendicularly to the optical axis. In this way, the actual four level stair grating could be adjusted to be either right-handed or left-handed.

By using the optical arrangements shown in FIGS. 1 and 2, and adjusting these so that maximum power appears in the diffraction order +1 after G2, the optical power in the lowest diffraction orders after G2, the total power transmitted by G2, and the power impinging on G1 was measured. The results are summarized in Table 1, which also shows the corresponding maximum theoretical values.

TABLE 1
Power in diffraction orders versus power transmitted by G2

| | |
|---|---|
| Theoretical | Measured |

| | Orders transmitted from G1 | | | | |
|---|---|---|---|---|---|
| Diffraction | | | | Reflection | Transmission |
| order | ±1, ±3 | ±1, ±3, ±5 | All orders | (±1, ±3) | (±1, ±3, ±5) |
| −5 | 0 | 0.011 | 0 | 0.012 | 0.016 |
| −3 | 0.182 | 0.129 | 0.090 | 0.150 | 0.132 |
| −1 | 0.005 | 0.003 | 0 | 0.027 | 0.024 |
| 0 | 0 | 0 | 0 | 0.012 | 0.011 |
| 1 | 0.769 | 0.777 | 0.811 | 0.702 | 0.731 |
| 3 | 0.012 | 0.002 | 0 | 0.063 | 0.054 |
| 5 | 0 | 0.011 | 0.032 | 0.009 | 0.011 |

Compared to the power impinging on G1, the measured power fractions in the order +1 was 42% and 52% for the reflection mode and the transmission mode, respectively. If zero losses of the Fresnel reflections are ignored, the corresponding values become 69,3% and 72,5%, respectively. By including Fresnel reflections, with the exception of any interference caused by these, the corresponding theoretical values are 52,6% and 58,3%, respectively.

The examples described above demonstrates that it is possible, by using two binary phase structures with pixel sizes in the range of 10 μm, and with the aid of adequate imaging optics, to synthesize phase gratings in four levels, giving a beam selectivity, with respect to diffraction order, close to the theoretical limit. The efficiency according to the examples is about 42/52,6=80% (reflection mode), and 52/58,3=89% (transmission mode) of the values predicted by theory, when allowance is made for the physical limitations of the arrangement: The Fresnel reflections in the imaging optics and gratings, and the spatial low pass filtration. By AR-coating the gratings and their substrate, the overall efficiency might be improved from 52% to about 60% in the transmission experiment.

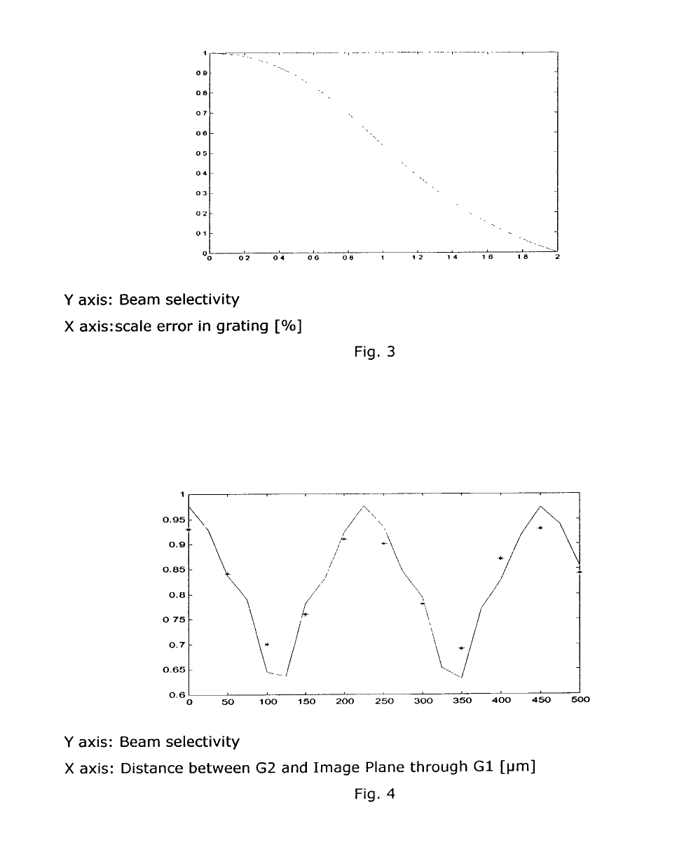

In order to obtain high beam selectivity between the diffraction orders +1 and −1, it is required that the periods of the two interfering gratings correspond closely. If the periods do not correspond closely, the diffraction beams will, apart from the fact that beam selectivity decreases, no longer be diffraction limiting. It is reasonable to assume that a high beam selectivity requires that the lateral phase error, due to incorrect scaling across the laser beam, is less than π/2. This criterion is quantified through the following difference:

$$\frac{Δ Λ}{Λ} \leq \frac{1}{4 \cdot N} , \qquad ( 1 )$$

in which ΔΛ is the fitting error between the gratings. Λ is the grating period, and N is the number of grating periods within the diameter of the laser beam 1/e². According to the examples, the diameter of the impinging laser beam was about 2.0 mm, which gave N≈84. Equation (1) then requires that the fitting error in the grating period is less than 0,3%. In order to study the influence of scale error in more detail, a computer simulation was carried out, and the result is shown in FIG. 3. More specifically, FIG. 3 shows a computer simulation of maximum beam selectivity between the diffraction orders +1 and −1 versus scale error during reproduction. The number of periods within the diameter of the laser beam is N=84. Beam selectivity is defined as the difference between the power in the order +1 and −1, divided by the sum of these.

When defining the beam selectivity as the difference between the power in the orders +1 and −1, and the sum of these, the simulations show that the maximum beam selectivity is better than 0.95 when equation (1) is satisfied. (With a given scale error, the beam selectivity is dependent upon the relative phase between the two gratings, and maximum beam selectivity is obtained at one specific relative phase.) The beam selectivity in the transmission measurements (cf. Table 1) was 0.94, which means that the scale error was less than 0.4% in the experiment.

However, the scale error may have been less than 0.3%, since factors other than scale error also reduce the beam selectivity. The edges of the grating lines are slightly rounded, the grating depths are not perfect, and the image plane of G1 does not coincide perfectly with the plane through G2. Further, in the transmission mode, the grating lines of G1 and G2 possess an angular error, referred to as Δφ. Through reasoning similar to the one leading up to equation (1), we find that high beam selectivity requires that the following criterion is satisfied:

$$Δ ϕ \leq \frac{1}{4 N} . \qquad ( 2 )$$

Next, the importance of crisp imaging is discussed. Using the expression for focusing depth, d_{f}=λ×f₁₉₀ ², we obtain d_{f}=5.0 μm for the transmission mode, and d_{f}=8.2 μm in the arrangement for reflection mode. However, Table 1 shows that a beam selectivity better than 0,98 is obtained when using the three lowest orders only, which in our case corresponds to an effective f-number of 6.3, which yields d_{f}=25 μm. The latter value is the expected general tolerance in the normal case. In this experiment, in which periodic structures are reproduced, high beam selectivity is attained, due to the Talbot effect, with G2 localized in several different planes on the optical axis, cf. FIG. 4 (J. W. Goodman, Introduction to Fourier Optics, 2^{nd} ed. (McGraw-Hill, N.Y., 1996), pp. 87-90). FIG. 4 shows measured maximum beam selectivity as a function of positioning of G2 during the transmission experiment (asterisks). The solid line indicates simulated data. The period observed in FIG. 4 is about 250 μm, and the distance between a Talbot image and a phase inverted Talbot image in an adjacent phase is 227 μm for G2.

Even if the efficiency is limited, and the geometric tolerance narrow, it should be pointed out that the examples demonstrate that high beam selectivity between the first two diffraction orders is attainable in practice. The conclusion is that the method of grating reproduction may be used in the intended application of beam guiding. In practice, the arrangement for reflection mode is probably preferable, since angular adjustment errors are automatically eliminated, and since scale errors are more easily avoided. Besides, it is easier to find the correct plane for G1 and G2 in the reflection mode. Other advantages include compactness, and better mechanical stability.

Finally, it was noted that the described arrangements allow measurement of relative displacement between the G1 image and G2 in the order of 0.1 μm. In the transmission mode, this may be utilized to measure lateral movement on the sub-micron level. The arrangement for reflection mode allows measurement of mirror rotation down to about 0.1 arc seconds. Furthermore, it should be possible to extend the measurement principle to two dimensions.

1. An optical measurement device, comprising first phase grating and second phase grating, a light source, and at least two optical detectors, wherein said gratings are stationary binary gratings on transparent carrier, and said first phase grating being arranged to be reproduced, when illuminated with said light source, upon said second phase grating, as a coherent image, so that periods of said image of said first phase grating and said second phase grating have an integral relationship with respect to each other and said grating lines of first grating image and second grating are parallel and a relative positional displacement between said image of one phase grating on the other phase grating is registered by said at least two optical detectors.

2. The device according to claim 1, wherein a phase modulation depth of one grating is approximately 180° and the other one approximately 90°.

3. The device according to claim 1, wherein during a relative displacement between the image of the first phase grating and the second phase grating in a direction perpendicular to the grating lines, the power of the different beams (orders) diffracted from the second phase grating is changed.

4. The device according to claim 1, wherein by comparing the magnitude of the detector signals the positional displacement between the images of said first phase grating and said second phase grating is determined.

5. The device according to claim 1, wherein said positional displacement arises through relative displacement between the first and second phase gratings and the imaging optics in a direction perpendicular to the grating lines, or through rotation of a mirror that may be part of the imaging optics.

6. The device according to claim 1, further comprising at least one lens objective and a mirror.

7. The device according to claim 6, wherein grating lines of said first and second phase gratings are vertically oriented.

8. The device according to claim 6, wherein said phase gratings are mounted in a rear focal plane of the lens objective and said beams diffracted from said first phase grating are parallel when they leave said lens objective a first time, the individual beams converging towards said mirror.

9. The device according to claim 8, wherein a mirror is placed at a right angle with respect to an optical axis of the lens objective and in its front focal plane.

10. The device according to claim 6, wherein said mirror is rotatebly arranged about a vertical axis, which is parallel to said grating lines so that the image of the first phase grating is vertically displaced towards the grating lines, whereby through correct relative adjustment between the image of the first and second phase gratings an actual stair approximation of a saw tooth-grating with four levels may be produced.

11. The device according to claim 6, wherein the phase gratings are arranged on the same substrate.

12. The device according to claim 1, wherein said device comprises a serial arrangement of first and second phase gratings and lenses placed there between.

13. The device according to claim 12, wherein a laser beam that impinges on said first grating is diffracted and said diffracted beams after a first passage of the lens, forms after the second passage of the lens an image of the first grating at the second grating, where an actual phase grating with four levels is formed.

14. A method at an optical measurement device, comprising first phase grating and second phase grating, an illumination means, and at least two optical detectors, said first and second gratings being stationary binary gratings on transparent carrier, wherein said first phase grating is arranged to be reproduced upon illumination with the illumination means on said second phase grating, which image is coherently achieved, so that periods of the image of said first and second phase gratings are integrally related to each other and said grating lines of one grating image and the other grating are parallel, and registering a relative positional displacement between the image of one phase grating and the other phase grating by said at least two optical detectors.

15. The method according to claim 14, comprising rotatebly arranging a mirror about a vertical axis which is parallel to the grating lines so that the image of the first phase grating is horizontally displaced towards the grating lines, and through correct relative adjustment between the image of the first and second phase gratings produce an actual stair approximation of a saw tooth-grating with four levels.

16. The method according to claim 14, wherein a serial arrangement of first and second phase gratings and lenses placed there between.

17. The method according to claim 16, comprising the steps of directing a laser beam at the first grating, which beam is diffracted whereby said diffracted beams after a first passage of the lens, forms after the passage of the second lens an image at the second grating, where an actual phase grating with four levels is formed.
